(19) United States
(12) Patent Application Publication
(10) Pub. No.: US 2016/0016772 A1
(43) Pub. Date: Jan. 21, 2016

(54) METHOD AND DEVICE FOR FILLING A CONTAINER WITH A FILL PRODUCT

(71) Applicant: KRONES AG, Neutraubling (DE)

(72) Inventors: Florian Angerer, Neutraubling (DE); Josef Doblinger, Neutraubling (DE)

(21) Appl. No.: 14/801,661

(22) Filed: Jul. 16, 2015

(30) Foreign Application Priority Data
Jul. 18, 2014 (DE) 10 2014 110 159.6

(51) Int. Cl. B67C 3/00

(52) U.S. Cl. CPC B67C 3/007

(57) ABSTRACT

Methods for filling a container with a fill product using a filler valve that can be opened steplessly and devices for determining an actual volume flow are described. A required volume flow is specified, wherein for a specified value of the required volume flow, the filler valve is controlled to adopt a pre-stored open position. The pre-stored open position is determined by a prior control process for the specified required volume flow.

### CROSS REFERENCE TO RELATED APPLICATIONS

This application claims priority from German Patent Application No. DE 10 2014 110 159.6, filed on Jul. 18, 2014 in the German Patent and Trademark Office, the disclosure of which is incorporated herein by reference in its entirety.

### BACKGROUND

1. Technical Field

The present invention relates to a method and a device for filling a container with a fill product using a filler valve, which can be opened steplessly in combination with a device for determining an actual volume flow.

2. Related Art

From the state of the art, methods for filling a container with a fill product are known, in which the fill product is introduced using a filling element in the container that is to be filled. It is known thereby to vary the volume flow of the fill product into the container to be filled over the duration of the filling. It is for example known to fill at a low volume flow rate at the beginning of the filling process, in order for example to reduce an initial tendency of a fill product to foam, due to the height from which it must fall into the container to be filled and the impact of the fill product on the base of the container. In such a filling process, the volume flow is subsequently maximized, in order to achieve as rapid as possible filling of the container that is to be filled. From a certain fill level, or after a certain filling time, or when a certain fill volume has been filled, the volume flow introduced into the container is again reduced, in order both to reduce the tendency to foam and to make it easier to end the filling at a precise point. The filling process then ends—depending on the filling method that is used—when a specified fill height is reached in the container to be filled, or a specified fill weight is reached, or after a specified filling time, or when a specified fill volume is reached. The cut-off mechanisms that are used for this purpose are known in principle.

For filling containers with a fill product, for example in a beverage filling plant, it is known to use filling elements, which are usually disposed above the container that is to be filled, and which, among other functions, control the volume flow into the container by means of a product valve. A product valve, which may for example be accommodated in a filling element, usually includes a valve body, which is displaceable relative to a valve seat and which, when tightly accommodated in the valve seat, blocks the flow of the fill product, and, when lifted out of the valve seat, allows the fill product above the product valve to flow out.

The movement of the valve body relative to the valve seat is usually controlled pneumatically. The known pneumatic drives allow only two switching positions, namely a fully closed and a fully open switching position. Accordingly, the volume flow into the container can only be either switched on or switched off. Variation of the volume flow during the filling of the fill product into the container to be filled can be carried out for example by means of a throttle valve upstream of the actual filler valve. By means of this upstream throttle valve, the volume flow can thus be restricted or increased at the switching points to correspond to a specified required volume flow.

In order to vary the volume flow, it is alternatively known to provide a filler valve that can be opened substantially steplessly. In this manner, variation of the volume flow into the container to be filled can be achieved by a stepless variation of the opening of the filler valve itself. Such a filler valve that can be opened steplessly enables proportional control of the flow rate, in particular when it is coupled with a flow meter. By means of the flow meter, the actual volume flow is measured, and it is regulated to the volume flows corresponding to a required volume flow by means of the control of the filler valve that can be opened steplessly.

### SUMMARY

A method and a device for filling a container with a fill product that represents an improvement in filling characteristics are provided.

Accordingly, a method for filling a container with a fill product using a filler valve that can be opened steplessly and a device for determining an actual volume flow are described, wherein a required volume flow is specified. According to the present disclosure, for a specified value of the required volume flow, the filler valve is controlled to adopt a pre-stored open position, wherein the pre-stored open position was determined by a prior control process for the specified required volume flow.

Due to the controlled movement to a pre-stored open position for a specified value of the required flow volume, the actual volume flow can reach the required volume flow more rapidly, without the occurrence of excessive overshooting in the steplessly adjustable filler valve. In particular, the overshooting that would occur with a control process alone can be reduced or even eliminated by the controlled movement to the pre-stored open position. The rapidity with which, by means of the pre-stored open position, the filler valve can be moved to an open position that correlates with the required volume flow, results from the fact that the pre-stored open position was determined in a prior control process, and was thereby reached for this particular filler valve and for the prevailing ambient conditions.

In this manner it is possible, in one, several or all subsequent filling processes, to control the valve to adopt the open position which, in a prior filling process, it had already established as a pre-stored open position by means of a control system including the device for determining the actual volume flow. Accordingly the filler valve can move immediately to the open position that was determined in the prior filling process to be the open position most closely corresponding to the required volume flow. By this means a constant volume flow that corresponds to the required volume flow can be quickly reached, or achieved in a subsequent control process.

In various embodiments, the open position that is stored as the pre-stored open position is that which was reached in the previous control process immediately before a change in the value of the required volume flow. This ensures that the oscillations in the control process have settled as far as possible, and accordingly the pre-stored open position corresponds to the greatest possible extent to the specified required volume flow.

As a further development, the pre-stored open position can be determined as the mean value of the open positions for a specified required volume flow, in order to eliminate any oscillations at the end of the control process. In several embodiments, the mean value is thereby calculated over a specified segment of the required volume flow, for example a specified time segment, in order to give a differing weight to different control segments. These possibilities for determining the pre-stored open position enable possible transient effects, which may occur when the specified required volume flow again changes, to be averaged out, in order by this means to provide an improved pre-stored open position for the filler valve during the next filling process, even in the case of a control system in which the oscillations have not yet fully settled.

The pre-stored open position is, in some embodiments, set as the starting point for a subsequent control process. Accordingly, the filler valve is first controlled to adopt the pre-stored open position for the corresponding value of the required volume flow, then, based on this open position, the control process is again carried out, taking into account the measured actual volume flow. By means of the immediate movement to the open position, initial overshooting can first be avoided, and the subsequent control process can be performed on the basis of an improved starting position, namely the pre-stored open position. The control process enables a further refinement of the open position, and can also take account of changed conditions, such as a change in the temperature or the level of the fill product.

In several embodiments, the control process is begun only following a delay after the pre-stored open position is reached. Depending on the spring constants of the system, the subsequent control process can thus start only after the expiry of a specified time period, such that a constant actual volume flow first establishes itself at the pre-stored open position, and the system, in which oscillations have been excited by the switching process, settles. Only then is the control process carried out, on the basis of the actual volume flow which has now become constant.

In alternative embodiments, the open position is controlled based on a pre-stored open position only for selected filling processes, for example only for every second, fifth, tenth or fiftieth filling process. By this means, a particularly efficient filling method can be achieved, and a renewed control process is not necessary for every individual filling process. Depending on the speed at which change occurs in the operating parameters, for example the temperature and the fill level of the fill product above the filler valve, it can be specified that the control process takes place more or less frequently.

Thus the system learns with every filling process, so that after a finite number of filling processes have been performed the pre-stored open position substantially or exactly corresponds to the specified value of the required volume flow, and in principle no adjustment takes place if a subsequent control process is added. Accordingly, an exact filling process that is substantially free of overshooting can be achieved by controlling the filler valve, which can be opened steplessly, to adopt the applicable pre-stored open position.

The applicable pre-stored open position is thereby, in some embodiments, adopted via a ramp function, which in certain embodiments corresponds to the ramp function of the required volume flow. In this manner, the specified required volume flow can be attained in the optimum manner, without provoking excessive adjustment movements or overshooting.

The described method is in several embodiments carried out for each filler valve separately, so that it is possible to compensate for mechanical tolerances in the filler valves, as well as differing positioning and differing flow characteristics of the individual filler valves.

A device for filling a container with a fill product is described that includes a filler valve that can be adjusted steplessly, a device for determining an actual volume flow, and a controller for controlling the open position of the filler valve based on a specified required volume flow and the actual volume flow. The device further includes a control device. According to the present disclosure, the control device is designed and configured to carry out the method described above.

### BRIEF DESCRIPTION OF THE FIGURES

Further embodiments and aspects of the present invention are more fully explained by the description below of the figures.

FIG. 1 is a schematic representation of a filling process during a preceding filling process;

FIG. 2 is an enlargement of a segment of the filling process of FIG. 1;

FIG. 3 is a schematic representation of a filling process during a subsequent filling process; and

FIG. 4 is an enlargement of a segment of the filling process of FIG. 3.

### DETAILED DESCRIPTION

Examples of embodiments are described below with the aid of the figures. In the figures, elements which are identical or similar, or have identical effects, are designated with identical reference signs, and repeated description of these elements is in part dispensed with in the description below, in order to avoid redundancy.

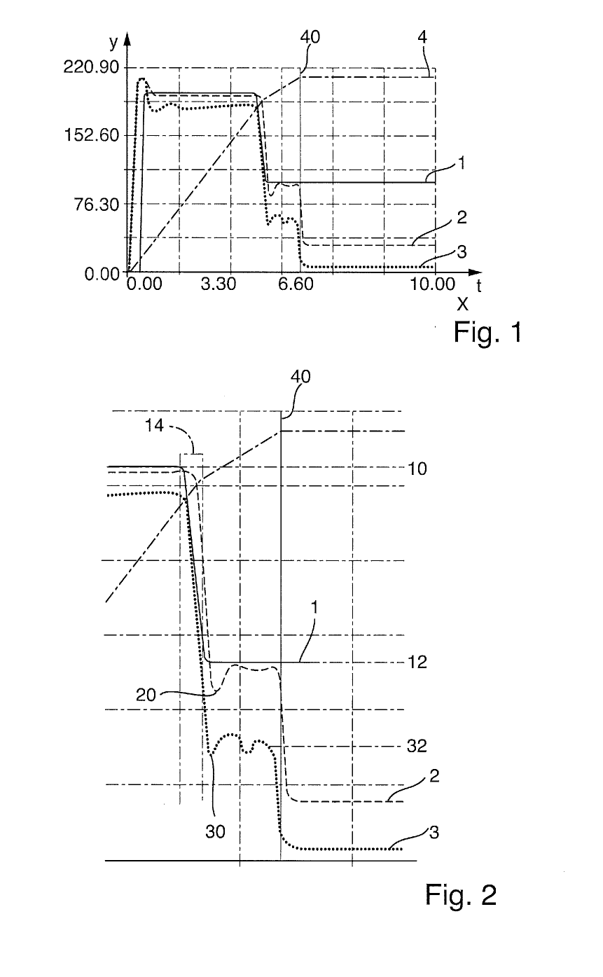

FIG. 1 shows schematically curves whose x-axis represents the time t of a filling process and on whose y-axis various parameters are plotted.

The solid line represents the specified required volume flow 1 that is specified by the operator of the plant for the applicable fill product in the filling process which is shown schematically in FIG. 1. The required volume flow 1 is usually specified by the operator of the plant differently for each type of container and for each fill product, in order to achieve filling of the container in a manner which does not degrade or damage the product and is at the same time efficient. In determining the required volume flow 1, an important role is played by the tendency of the fill product to foam, since if the tendency to foam is high towards the end of the filling process the filling needs to be carried out from an earlier point at a lower volume flow rate, in order to avoid excessive foaming and hence overflowing.

Initially, therefore, a required volume flow 1 with a high required volume flow 10 is specified, in order to fill the container rapidly. Then towards the end of the filling process, this is reduced to a lower required volume flow 12. In this, it is taken into account that a product valve cannot be closed abruptly, due to considerations of flow dynamics among other possible considerations, in order to avoid unnecessarily giving rise to oscillations in the system as a whole. Accordingly, the required volume flow 1 is switched from the high required volume flow 10 to the lower required volume flow 12 via a ramp function 14.

The dashed line curve in the figures represents the measured actual volume flow 2 of the fill product through the filler valve, measured for example by means of a flow meter or another method of measurement.

By means of a controller that continually compares the required volume flow 1 with the actual volume flow 2, a manipulated variable is determined, which is used to regulate the open position 3 of the filler valve.

The dotted line curve in the figures indicates the open position 3 of the filler valve. As can be seen from the figures, the open position 3 is correlated with the actual volume flow 2, since with a specified open position 3 a corresponding actual volume flow 2 is reached after a transient response.

The dot-dash curve shows the total fill product volume 4 that has flowed into the container over the entire course of the filling process. The fill product volume 4 is thus the time integral over the actual volume flow 2. Closure of the filler valve is reached at the switch-off time point 40, at which the desired fill volume for the applicable container is reached. At the switch-off time point 40 the filler valve is closed and the filling process is accordingly ended.

For conventional methods of filling a container with a fill product using a filler valve that can be opened steplessly, a PD controller or a PID controller is usually provided. This controller then carries out the control processes. The applicable PD controller or PID controller is accordingly parameterized identically for all filler valves, which does not achieve optimum control results since the individual filler valves or filling points usually differ slightly from each other. Because of this, the manipulated variables relating to the required volume flow 1 cannot be optimally determined, and in this case no individual adjustment of each individual filler valve or filling element takes place.

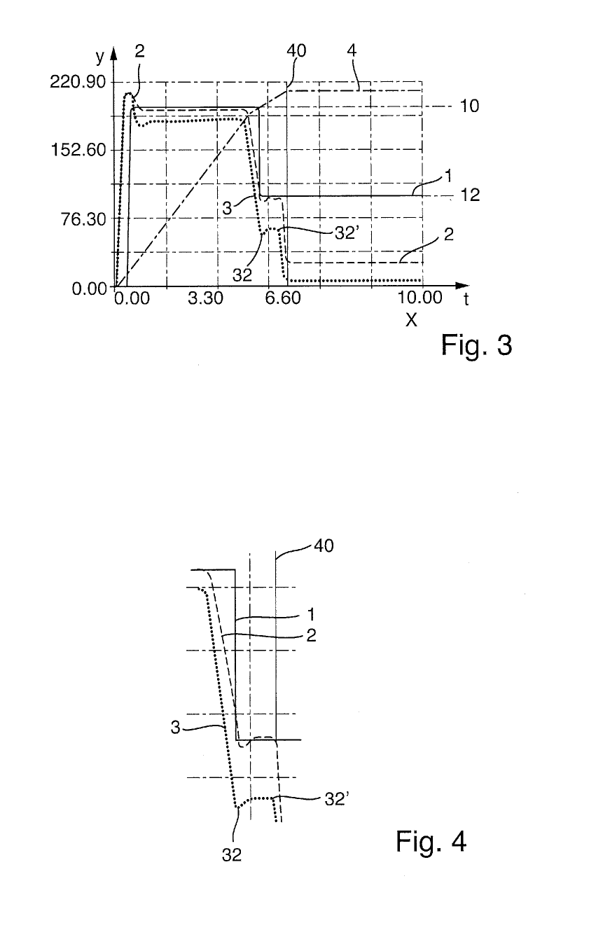

This accordingly results in overshooting 30 in the open position 3 of the filler valve, as can be seen for example in FIGS. 1 and 3, which results in corresponding overshooting 20 of the actual volume flow 2. The overshooting 20 of the actual volume flow 2 also depends on the spring constants of the system, which is again caused to oscillate each time the filler valve is switched.

Such overshooting 20, 30 occurs for example when the required volume flow 1 is reduced towards the end of the filling process from the high required volume flow 10 to the lower required volume flow 12. The overshooting 20, 30 in this case affects both the open position 3 and the actual volume flow 2.

It can be seen from FIGS. 1 and 2 that after the required volume flow 1 falls to the lower required volume flow 12, no stable state is reached by the switch-off time point 40. Instead, the actual volume flow 2 oscillates around the lower required volume flow 12, with the result that the open position 3 of the filler valve also oscillates correspondingly. The overshooting 20, 30 during the process of switching the filler valve from the high required volume flow 10 to the lower required volume flow 12, as well as the subsequent oscillation up to the switch-off time point 40, result from, among other factors, non-optimal parametrization of the PD controller. Because of this, the time available is too short to reach a fully stable control state for the open position 3 of the filler valve at the lower required volume flow. At the switch-off time point 40, prior to its actual closure, the filler valve therefore adopts an open position 32 which can vary for every individual filling process.

The curves that are shown in FIGS. 1 and 2 of the actual volume flow 2 and the open position 3 are fully controlled curves, in which a PD controller is supplied only with the required volume flow 1 and the actual volume flow 2, from which the applicable manipulated variable for regulating the open position 3 is determined. The overshooting 20, 30 and the subsequent oscillation result from, among other factors, the fact that the controller is not optimally parametrized for the specific instance in which it is used.

In order to promote the reaching of a steady state, and hence achieve a reduction of the overshooting and subsequent oscillation of the actual volume flow 2 and the open position 3, it is proposed that, in a control process such as that shown in FIGS. 1 and 2, the open position 32 at the switch-off time point 40 is stored as the pre-stored open position 32 for the corresponding lower required volume flow 12 for a subsequent filling process.

In a subsequent filling process, such as that shown for example in FIGS. 3 and 4, the valve is controlled to adopt the pre-stored open position 32 directly for the specified lower required volume flow 12, so that the pre-stored open position 32 is used as the starting position for the further control process at the lower required volume flow 12. By this means the excessive overshooting 20, 30 in FIGS. 1 and 2 of the open position 3 and the actual volume flow 2 can be reduced, since the valve is moved directly to the pre-stored open position 32 for the specified required volume flow 12.

The control process is then continued as before, such that, starting from the pre-stored open position 32, the open position 3 is again controlled, based on the actual volume flow 2, which is detected by means of the flow meter, to correspond to the lower required volume flow 12 that is specified via the required volume flow 1.

As is indicated for example in FIG. 4, in this case a quasi-static level of the open position 3 has been reached at the switch-off time point 40, at only the second iteration. This open position 3 is in turn stored as the new pre-stored open position 32′ for the next filling process. Thus, in the example embodiment that is shown, a quasi-stable state, i.e. a quasi-stable open position 3, can be reached after only two iterations for a lower required volume flow 12 that is specified via the required volume flow 1.

In the next filling process, this new pre-stored open position 32′ is initially adopted in order to achieve the specified lower required volume flow 12. If the surrounding conditions, for example the pressure of the fill product in the filler valve, have not changed between the two filling processes, or have not changed significantly, it is possible by means of this second pre-stored open position 32′ for the actual volume flow 2 to reach the specified lower required volume flow 12 immediately.

The method described above can be used for any desired change in the required volume flow 1, not only for the reduction of the high required volume flow 10 to the lower required volume flow 12. For this purpose the current open position for the applicable required volume flow is stored by the controller before being changed in each case, and moved to directly at a subsequent filling process in each case as the starting point for the subsequent control.

Accordingly, after the open position 32′ is stored, if the surrounding conditions are the same, no further adjustment, or no significant further adjustment, needs to take place, with the result that the control process is rapid and simple. If, however, the surrounding conditions change, adjustment again takes place, such that in the next filling process it is again possible to adopt an optimized starting position by means of the open position which is pre-stored at that time.

With a curve of the required volume flow 1 that has repeatedly reached the same value of the required volume flow in a filling process, the open position that was stored in each case when the value was previously reached can be used as the initial value on the next occasion that it is desired to reach that value.

The pre-stored open position 32, 32′ for the specified required volume flow 1, which in the example embodiment shown in FIGS. 1 and 2 is reached at the switch-off time point 40, or at the time point at which a change in the specified required volume flow occurs, can also be determined by other means.

In particular, it is also possible here to calculate a mean value of the open position 1 either over a specified time segment, for example the last second before the change in the required volume flow 1, or over the entire stage, starting from the change in the required volume flow 1 and lasting until another change in the required volume flow 1. When the mean value is calculated, it is for example possible to compensate better for the oscillation processes or decay processes, which can be seen particularly clearly in FIG. 2, so that the pre-stored open position that is determined in this manner can correspond to the specified required volume flow 12 even more accurately than an open position 32 that is simply determined when the switch-off time point 40 is reached.

Furthermore, the control process following the reaching of the pre-stored open position 32, 32′ can either be started immediately after the pre-stored open position is reached, or only after a certain delay following the time at which the pre-stored open position 32, 32′ is reached. Depending on the spring constants of the system, it may be expedient first to reach the pre-stored open position 32, 32′, then wait until the system has settled, and only then proceed with the further control process. In this case, for example, after the pre-stored open position 32, 32′ is reached a time delay of 100 milliseconds to 500 milliseconds can be provided, following which the control process using a PD controller or PID controller resumes.

The speed at which the movement to the pre-stored open position 32, 32′ from the previous open position 1 takes place in several embodiments results from the ramp function 14 that is specified via the required volume flow 1. Here, as is for example shown schematically in FIG. 2, a ramp function 14 is provided for the change of open position 3 from the high required volume flow 10 to the lower required volume flow 12, and is then used as a specification for the movement of the filler valve to the pre-stored open position 32, 32′.

In this manner it is further possible to enable an optimized adoption of open positions for each individual filler valve in a filling plant, independently of the originally specified set of parameters of a PD controller or PID controller.

Concerning the required volume flow 1, it should be noted that the overshooting 20, 30 that is shown occurs with conventional PD controllers or PID controllers particularly when it is necessary to descend steep ramps, such as can be clearly seen in FIGS. 1 and 2. In normal filling operations, these steep ramps are usually followed by plateaus, in which the required volume flow 1 is intended to be held constant. The open position 3 of the filler valve that is reached at the end of each required volume flow 1 plateau is the position which should optimally have already been reached at the beginning of the control process, i.e. at the beginning of the applicable plateau. Accordingly, the open position 3 which is adopted at the end of the plateau can then be used as the pre-stored open position 32, 32′, as it were as the “experience-based value” for the following filling process.

When the system has thereby learned the differing open positions 32, 32′ for all required volume flows 1, the entire filling process can be carried out merely by adoption of the applicable pre-stored open positions 32, 32′, without subsequent control processes.

It is further possible for subsequent control processes not to be carried out for every filling process, but only for example for every second, third, tenth, fiftieth etc. filling process. The remaining filling processes are carried out merely by means of adoption of the pre-stored open positions 32, 32′.

In order to be able to carry out the above-mentioned method, a device is in certain embodiments provided with a filler valve that can be opened steplessly, and that can be moved by a suitable actuator to the applicable specified open position 3. By means of a controller, which in itself is known, for example a PID controller or a PD controller, the open position 3 of the filler valve can be regulated according to a specified required volume flow 1 by the use of a flow meter connected with the controller. Accordingly, the open position 3 of the filler valve is regulated such that the specified required volume flow 1 is reached as rapidly as possible.

A control device is also provided, which is designed and configured to store for each specified required volume flow 1 an open position 32, 32′ of the filler valve for the next filling, or in order to reach subsequently a value of the required volume flow 1 which was previously obtained. In particular, an open position 32, 32′ of the filler valve is stored after having been reached for the applicable specified required volume flow 1 in as settled as possible a state of the control process. This is the case for example at the end of a plateau of the specified required volume flow 1, wherein the pre-stored open positions 32, 32′ can also be calculated from the control process and the corresponding open positions 3 that are adopted.

By means of the control device, during the next filling process the corresponding pre-stored open position 32, 32′ for each specified required volume flow 1 can be moved to, in order either to carry out the filling process with this pre-stored open position 32, 32′, or else to provide a starting point for a new control process.

The applicable control device is in some embodiments configured firstly such that it can carry out the method described above, and secondly such that it can drive each filler valve separately, in such a manner that an optimized filling process can be provided for each individual filler valve in a filling plant.

To the extent applicable, all individual features described in the individual example embodiments can be combined with each other and/or exchanged, without departing from the field of the invention.

1. A method for filling a container with a fill product using a filler valve, comprising:
receiving a specified required volume flow; and
controlling the filler valve to adopt a pre-stored open position for the specified required volume flow, wherein the pre-stored open position is determined by a previous control process for the specified required volume flow and wherein the filler valve is configured to open steplessly.

2. The method of claim 1, wherein an open position that is stored as the pre-stored open position is the position that was reached in the previous control process prior to a change in a value of the specified required volume flow.

3. The method of claim 1, wherein the pre-stored open position is a mean value of a plurality of open positions for the specified required volume flow.

4. The method of claim 3, wherein the mean value is calculated over a specified segment of the required volume flow.

5. The method of claim 4, wherein the specified segment comprises a specified time segment.

6. The method of claim 1, further comprising setting the pre-stored open position as a starting point for a subsequent control process.

7. The method of claim 6, further comprising beginning the subsequent control process only following a delay after the pre-stored open position is reached.

8. The method of claim 1, further comprising controlling an open position based on a pre-stored open position for every filling process used.

9. The method of claim 1, further comprising controlling an open position based on a pre-stored open position only for selected filling processes.

10. The method of claim 1, wherein the pre-stored open position is adopted via a ramp function.

11. The method of claim 1, further comprising individually controlling filler valves of a beverage filling plant.

12. A method for filling a container with a fill product using a filler valve, comprising:
receiving a specified required volume flow;
storing an open position at a switch-off time point for a filling process for the specified required volume flow as a pre-stored open position; and
controlling the filler valve in a subsequent filling process to adopt the pre-stored open position for the specified required volume flow, wherein the filler valve is configured to open steplessly.

13. The method of claim 12, further comprising determining whether surrounding conditions have changed.

14. The method of claim 13, wherein the surrounding conditions comprise a pressure of the fill product in the filler valve.

15. The method of claim 13, wherein the surrounding conditions have changed and the method further comprises adjusting the pre-stored open position.

16. The method of claim 12, further comprising beginning the subsequent filling process immediately after the pre-stored open position is reached.

17. A device for filling a container with a fill product, comprising:
a filler valve configured to be adjusted steplessly;
a device for determining an actual volume flow;
a controller for controlling an open position of the filler valve based on a specified required volume flow and an actual volume flow; and
a control device configured to control the filler valve to adopt a pre-stored open position for the specified required volume flow.

18. The device of claim 17, wherein the control device is further configured to store the pre-stored open position.

19. The device of claim 17, wherein the control device is further configured to drive filler valves in a beverage filling plant separately.

20. The device of claim 17, wherein the pre-stored open position is a mean value of a plurality of open positions for the specified required volume flow.
